(19) United States
(12) Patent Application Publication
(10) Pub. No.: US 2025/0060945 A1
(43) Pub. Date: Feb. 20, 2025

(54) AUTOMATED ARRANGEMENT OF NODES, REPRESENTING A SOFTWARE APPLICATION, IN A GRAPHICAL USER INTERFACE

(71) Applicant: Boomi, LP, Conshohocken, PA (US)

(72) Inventors: Thomas M. Fullalove, Exeter (GB); Benjamin K. Fullalove, Cranbrook (GB)

(21) Appl. No.: 18/235,514

(22) Filed: Aug. 18, 2023

(51) Int. Cl. G06F 8/34; G06F 3/0486

(52) U.S. Cl. CPC G06F 8/34; G06F 3/0486

(57) ABSTRACT

Some integration services provide a virtual canvas on which users can construct software applications (e.g., implementing workflow automation processes), represented as nodes and edges in a graph, using drag-and-drop operations. These graphs can become quite complex and disorganized. To complicate matters, the graphs may comprise groups of nodes that are managed as a single unit and need to be preserved. Standard graph arrangement algorithms are not applicable to graphs with groups. Accordingly, embodiments automatically rearrange graphs to optimize their arrangements, while accounting for groups, using a recursive, multi-level automated-arrangement process.

### BACKGROUND

### Field of the Invention

The embodiments described herein are generally directed to a graphical user interface, and, more particularly, to automatically arranging nodes in a graph, representing a software application, in a graphical user interface.

### Description of the Related Art

A number of services exist for generating workflow automation processes. For example, Boomi® of Chesterbrook, Pennsylvania, provides Flow™. Flow™ enables a user to build a software application (e.g., implementing a workflow automation process) with low-code and cloud-native technologies. In particular, the user may drag and drop visual representations of components of a software application, within a virtual canvas, and connect those components to represent a flow between the components. These components correspond to pre-built code that can be integrated, according to the user-specified connections, to produce the software application, Thus, the user can construct a software application with no or minimal coding.

However, since users can place the visual representations of the components of the software application anywhere on the virtual canvas, the virtual canvas can become disorganized, especially for complex software applications with large numbers of components. This complexity is exacerbated by the fact that, at least in the Flow™ product, users can group subsets of the components together, and move those groups around on the virtual canvas as a single unit. Thus, it would be advantageous for the graphical user interface to provide an automated-arrangement feature that a user can execute to quickly organize the visual representations on the virtual canvas.

### SUMMARY

Accordingly, systems, methods, and non-transitory computer-readable media are disclosed for the automated arrangement of nodes in a graph, representing a software application, in a graphical user interface.

In an embodiment, a method comprises using at least one hardware processor to: generate a graphical user interface comprising a virtual canvas; receive a placement on the virtual canvas of a plurality of nodes in a graph, wherein each node is a visual representation of a component of a software application; receive a placement on the virtual canvas of one or more edges in the graph, wherein each edge is a visual representation of a connection between two components of the software application; receive an automated-arrangement operation; and in response to receiving the automated-arrangement operation, determine whether or not the graph contains at least one group of two or more nodes, when determining that the graph contains at least one group, until no groups remain, select a deepest group in the graph, apply a graph arrangement algorithm to the selected group to produce an arranged group, calculate dimensions of the arranged group, and replace the group in the graph with a mock node having the calculated dimensions, apply the graph arrangement algorithm to an entirety of the graph, after applying the graph arrangement algorithm to the entirety of the graph, replace each mock node in the graph with the group that was replaced by that mock node to produce a rearranged graph, and update the placements on the virtual canvas of the plurality of nodes and the one or more edges, according to the rearranged graph.

Calculating the dimensions of the arranged group may comprise calculating a width and height of a smallest bounding box that contains all nodes in the arranged group. The mock node may have a shape and size of the smallest bounding box.

Replacing the group in the graph with the mock node may comprise, for each edge that has a first end connected outside the arranged group and a second end connected to the arranged group or a node within the arranged group, connecting the second end of the edge to the mock node.

Replacing each mock node in the graph with the group that was replaced by that mock node may comprise replacing any shallower mock nodes before replacing any deeper mock nodes.

Receiving the automated-arrangement operation may comprise receiving a user selection of an auto-arrangement input in the graphical user interface.

Receiving the placement on the virtual canvas of the plurality of nodes in the graph may comprise, for each of the plurality of nodes, receiving a drag-and-drop operation of the respective visual representation of the component from a virtual pallet onto the virtual canvas. Receiving the placement on the virtual canvas of the one or more edges in the graph may comprise, for each of the one or more edges, receiving a drawing operation of the respective visual representation of the connection between two visual representations of components.

The graph arrangement algorithm may optimize an arrangement of nodes in the selected group according to one or more optimization criteria.

The method may further comprise using the at least one hardware processor: receive a deployment operation; and in response to receiving the deployment operation, generate the software application according to the graph, and deploy the software application to a software environment.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure in which one or more of the processes described herein may be implemented, according to an embodiment;

FIG. 2 illustrates an example process for the automated arrangement of nodes in a graph, representing a software application, in a graphical user interface, according to an embodiment;

FIGS. 3A and 3B illustrate the automated arrangement of nodes within a screen of a graphical user interface, according to an embodiment; and

FIG. 4 illustrates an example processing system, by which one or more of the processes described herein may be executed, according to an embodiment.

### DETAILED DESCRIPTION

In an embodiment, systems, methods, and non-transitory computer-readable media are disclosed for the automated arrangement of nodes in a graph, representing a software application, in a graphical user interface. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Example Infrastructure

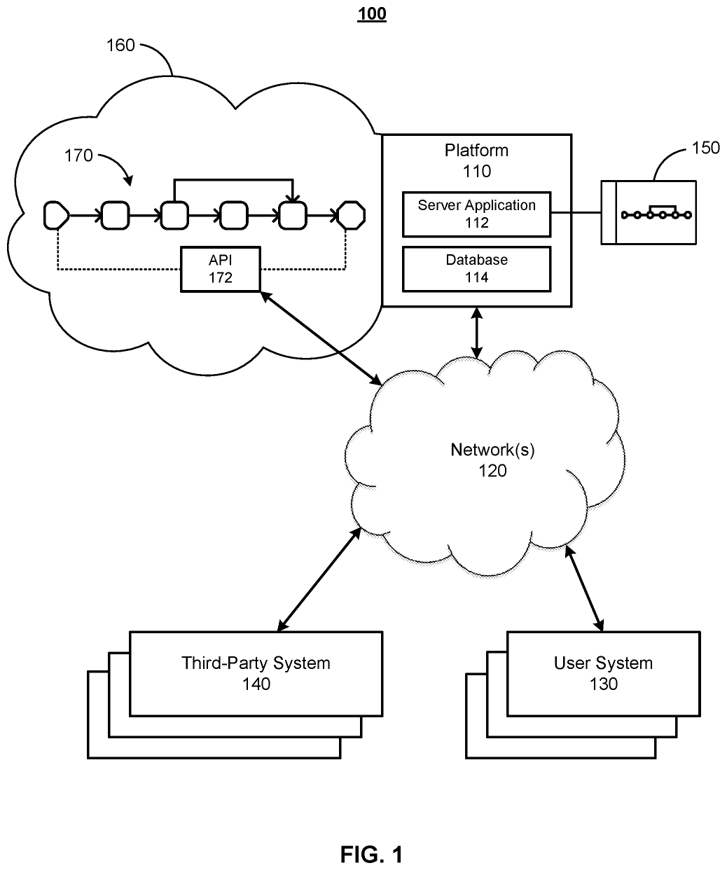

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may execute a server application 112, which may comprise one or more software modules implementing one or more of the disclosed processes. Platform 110 may also manage one or more databases 114, which may store data used by server application 112.

Platform 110 may be communicatively connected to one or more networks 120. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems, including user system(s) 130 and/or third-party system(s) 140, through a single set of network(s) 120, it should be understood that platform 110 may be connected to the various systems via different sets of one or more networks. For example, platform 110 may be connected to a subset of systems via the Internet, but may be connected to another subset of systems via an intranet.

As mentioned above, platform 110 may be communicatively connected to one or more user systems 130 via network(s) 120. While only a few user systems 130 are illustrated, it should be understood that platform 110 may be communicatively connected to any number of user systems 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of a software developer that has a user account for accessing server application 112 on platform 110.

Server application 112 may manage a software environment 160. In particular, server application 112 may provide a graphical user interface 150 and backend functionality, including one or more of the processes disclosed herein, to enable users, via user systems 130, to construct, edit, save, test, and/or deploy software applications 170 within software environment 160. Of particular relevance to the present disclosure, the backend functionality may include an automated-arrangement process that is operable via graphical user interface 150.

Although only a single software application 170 is illustrated, it should be understood that, in reality, software environment 160 may comprise any number of software applications 170. Each software application may be associated with an organization. Each organization may be associated with one or more user accounts by which respective user(s) manage the software application.

Each software application 170 may implement a workflow automation process for an organization. A workflow automation process may automate a business workflow. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. By automating a business workflow, via software application 170, the organization can reduce the need for manual work, especially on repetitive tasks.

In some cases, software application 170 may comprise or interact with one or more integration processes. An integration process may represent a transaction involving the integration of data between two or more systems, and may comprise a series of steps that specify logic and transformation requirements for the data to be integrated. Each step may transform, route, and/or otherwise manipulate data to attain an end result from input data. For example, a basic integration process may receive data from one or more data sources (e.g., via an application programming interface), manipulate the received data in a specified manner (e.g., including analyzing, normalizing, altering, updated, enhancing, and/or augmenting the received data), and send the manipulated data to one or more specified destinations. An integration process may represent a business workflow or a portion of a business workflow or a transaction-level interface between two systems, and comprise, as one or more steps, software modules that process data to implement the business workflow or interface. While software application 170 will primarily be described herein as a workflow automation process, software application 170 may instead be a single integration process, or any other set of connected components that can be represented as a graph within a graphical user interface 150.

The user of a user system 130 may authenticate with platform 110 using standard authentication means, to access server application 112 in accordance with permissions or roles of the associated user account. The user may then interact with server application 112 to construct, develop, edit, delete, test, deploy, and/or otherwise manage one or more software applications 170, for example, within a larger platform within software environment 160. It should be understood that multiple users, on multiple user systems 130, may manage the same software applications 170 and/or different software applications 170 in this manner, according to the permissions or roles of their associated user accounts.

Each software application 170 may be communicatively coupled to network(s) 120. For example, each software application 170 may comprise an application programming interface (API) 172 that enables clients to access software application 170 via network(s) 120. A client may push data to software application 170 through application programming interface 172 and/or pull data from software application 170 through application programming interface 172.

One or more third-party systems 140 may be communicatively connected to network(s) 120, such that each third-party system 140 may communicate with a software application 170 in software environment 160 via application programming interface 172. Third-party system 140 may host and/or execute a software application that pushes data to software application 170 and/or pulls data from software application 170, via application programming interface 172. Additionally or alternatively, a software application 170 may push data to a software application on third-party system 140 and/or pull data from a software application on third-party system 140, via an application programming interface of the third-party system 140. Thus, third-party system 140 may be a client or consumer of one or more software application 170. As examples, the software application on third-party system 140 may comprise, without limitation, enterprise resource planning (ERP) software, customer relationship management (CRM) software, accounting software, and/or the like.

### 2. Example Process

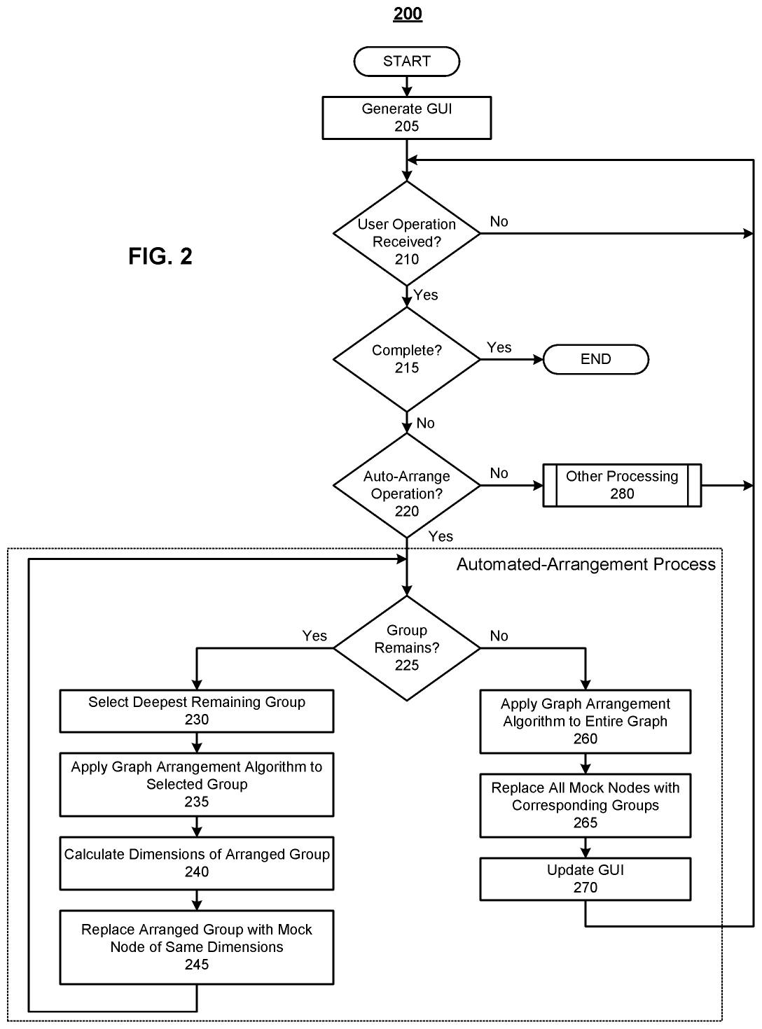

FIG. 2 illustrates an example process 200 for the automated arrangement of nodes of a graph, representing a software application 170, in graphical user interface 150, according to an embodiment. Process 200 may be implemented by server application 112. While process 200 is illustrated with a certain arrangement and ordering of subprocesses, process 200 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

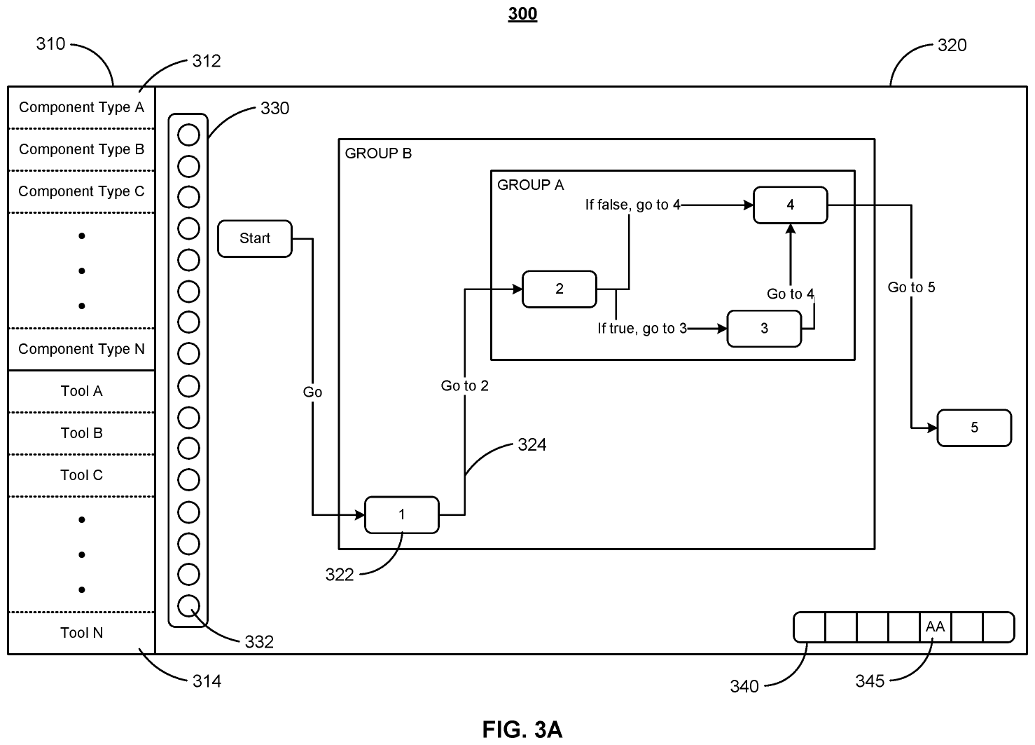

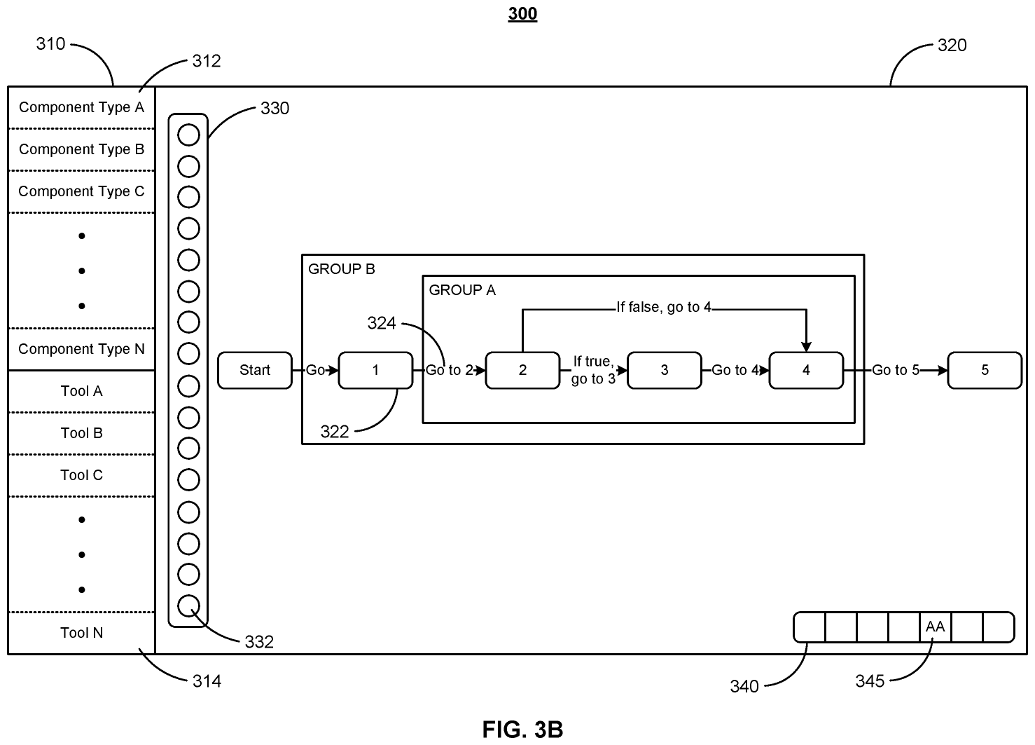

Initially, in subprocess 205, a graphical user interface 150 is generated. For example, server application 112 may generate a screen (e.g., screen 300, illustrated in FIGS. 3A and 3B) of graphical user interface 150 for constructing a software application 170. The screen may comprise one or more inputs tied to various functionality available through the screen. The user may perform user operations on these inputs to initiate or otherwise access the respective functions.

For example, the screen may comprise a virtual canvas (e.g., virtual canvas 320, illustrated in FIGS. 3A and 3B) that accepts drag-and-drop operations on visual representations of the components of a software application 170. In particular, a user can drag and drop the visual representations of components at respective positions on the virtual canvas. The user can also form connections between the visual representations of the components that have been placed on the virtual canvas, for example, by performing a drawing operation of a visual representation of the connection between two visual representations of components.

It should be understood that the components, which are visually represented and connected on the virtual canvas, are nodes in a graph, and the connections are edges in the graph. Accordingly, to simplify the description, the visual representations of the components may be referred to herein as “nodes” and the connections between the visual representations of the components may be referred to herein as “edges.” In the context of software applications 170, this graph is generally a directed graph. In other words, the edges between the nodes have direction. Typically, the edges are unidirectional, such that one end (i.e., the source end) of the edge represents a connection point to source and the other end (i.e., the destination end) of the edge represents a connection point to a destination. The graph may be, but is not limited to, a tree. For example, the graph may contain one or more cycles, in which the edges between nodes form a loop.

A component, represented as a node, may represent any type of component used in a software application 170. For example, a node could be a step, a pre-built group of steps, or the like, within a workflow. The step may be visual in nature (e.g., collecting data via a form or other inputs, displaying data in a table or chart, etc.) or may be non-visual in nature (e.g., connecting to a service to load data, save data, delete data, initiate an action, or the like, altering data in the workflow, initiating other software applications 170, representing other workflows, performing routing logic, or the like) A connection, represented as an edge, may represent a flow between two components. For example, an edge may represent the journey of a user of the software application 170 and/or the user's data, from step to step through the workflow. An arrangement of nodes and edges refers to the layout of the nodes and edges (e.g., relative positions) on the virtual canvas, the sizes of the nodes, the lengths and bends in the edges, and the like.

The screen, generated in subprocess 205, may also comprise other inputs. These other inputs may include an auto-arrangement input (e.g., virtual button) that, when selected, initiates an automated-arrangement process that automatically arranges the nodes in the graph, and then updates graphical user interface 150 to reflect the arranged nodes. Other potential inputs include, without limitation: a save input that, when selected, saves the graph; an exit input that, when selected, saves the graph, and redirects to a new screen; a deployment input that, when selected, initiates a deployment operation that generates a software application 170 according to the graph, and deploys the generated software application 170 to software environment 160; and/or a test input that, when selected, initiates a test operation that generates a software application 170 according to the graph, and executes the generated software application 170 in a test run. One or more of these inputs may represent a completion of the software application 170 and of process 200.

In an embodiment, two or more nodes within the graph may be logically grouped together. In addition, a group may be nested within another group, and a group may nest one or a plurality of other groups. Each group of nodes may be managed as a single unit with respect to various functions. The group may also be moved, deleted, and/or configured as a single unit. More generally, one or more of the functions that can be applied to a node may also be applicable to a group as a whole, to thereby increase the efficiency of constructing a software application 170. In an embodiment, an edge can only be connected to a particular node within a group, and not to the group itself. However, in an alternative embodiment, an edge can be connected to a group, as well as to an individual node within the group.

In subprocess 210, it is determined whether or not a user operation has been received. Server application 112 may receive a user operation via one or more of the inputs in the screen of graphical user interface 150. The user operation may initiate the automated arrangement of the nodes in the graph, complete the construction of the software application 170, position or reposition nodes, form edges between nodes, and/or initiate or perform any other available function. While only a few inputs and/or functions may be described herein, it should be understood that graphical user interface 150 may comprise any number of additional inputs and/or functions that are relevant to integration management. When a user operation is received (i.e., “Yes” in subprocess 210), process 200 proceeds to subprocess 215. Otherwise, while no user operation is received (i.e., “No” in subprocess 210), process 200 waits for a user operation.

In subprocess 215, it is determined whether or not the user operation represents the completion of the software application 170. For example, the user may have selected a save input, exit input, deploy input, and/or test input to trigger subprocess 210. When the user operation represents the completion of software application 170 (i.e., “Yes” in subprocess 215), process 200 ends. Otherwise, when the user operation does not represent the completion of software application 170 (i.e., “No” in subprocess 215), process 200 proceeds to subprocess 220.

In subprocess 220, it is determined whether or not the user operation represents the automated arrangement of the nodes. For example, the user may have selected the auto-arrangement input in subprocess 210 to initiate the automated-arrangement operation. When the user operation is the automated-arrangement operation (i.e., “Yes” in subprocess 220), process 200 proceeds to subprocess 225. Otherwise, when the user operation represents some other function (i.e., “No” in subprocess 220), other processing, associated with the selected function, may be performed in subprocess 280, and process 200 may return to subprocess 210 to await the next user operation.

Subprocesses 225-270 represent an automated-arrangement process for the graph. As mentioned above, this automated-arrangement process may be initiated by a user's selection of the auto-arrangement input in the screen that was generated in subprocess 205. The input to the automated-arrange process is a graph with an input arrangement. At a high level, subprocesses 230-245 represent one iteration of a recursive loop that is performed for each group of nodes in the graph, starting from the deepest group. As mentioned above, a group may be nested within another group. In this case, the nested group is at a lower depth than the nesting group. It should also be understood that, in some cases, there may be no groups of nodes within the graph, for example, because the user did not utilize groups during construction of the software application 170.

In subprocess 225, it is determined whether or not any group in the graph remains to be considered in an iteration of subprocesses 230-245. When at least one group remains to be considered (i.e., “Yes” in subprocess 225), process 200 proceeds to subprocess 230. Otherwise, when no groups remain to be considered (i.e., “No” in subprocess 225), process 200 proceeds to subprocess 260.

In subprocess 230, the deepest group, remaining to be considered, is selected. As mentioned above, the depth of a group is measured as the level of nesting of that group. For example, a group that is not nested within any other group will be at the first or highest level of depth, a group that is nested within another group that is not nested within any other group will be at the second level of depth (i.e., deeper than the first level, shallower than the third level), a group that is nested within another group that is nested within another group that is not nested within any other group will be at the third level of depth (i.e., deeper than the first and second levels), and so on and so forth. It should be understood that a group may be at any depth level. In other words, the automated-arrangement process is capable of automatically arranging the graph, regardless of the depth of the graph.

If a plurality of groups are at the same depth, it generally does not matter which of the plurality of groups is selected first, since each of the plurality of groups will eventually be selected in an iteration of subprocess 230. Accordingly, any suitable selection method may be used. For example, the next group may be selected randomly. Alternatively, groups at the same level may be prioritized according to one or more prioritization criteria, which may prioritize the group that is first in order or last in order, the group with the most nodes or the fewest nodes, the group with the largest dimensions or the smallest dimensions, and/or the like.

In subprocess 235, a graph arrangement algorithm is applied to the group that was selected in subprocess 230. Notably, since the deepest group was selected in subprocess 230, the group will not contain any other groups. It should be understood that the group may have previously contained one or more other groups, but those other groups will necessarily have been replaced with a mock node, as described below with respect to subprocess 245. Thus, since there are no nested groups in the selected group, it is straightforward to apply a graph arrangement algorithm to the selected group. The output of subprocess 235 will be an optimized arrangement of the nodes and/or edges in the selected group.

The particular graph arrangement algorithm that is used in subprocess 235 is not essential to process 200. In general, the graph arrangement algorithm will attempt to optimize the arrangement of the nodes and/or edges in the selected group, relative to each other, according to one or more optimization criteria. The optimization criteria may comprise minimizing the dimensions of the group or the space consumed by the group, maximizing linearity or minimizing the number of bends in the edges, maximizing verticality or horizontality of the edges, minimizing the lengths of edges, minimizing edge crossings, maximizing symmetry, and/or the like. The graph arrangement algorithm may implement one or more graph drawing techniques, including, for example, force-based layout, spectral layout, orthogonal layout, tree layout, layered graph drawing, arc diagrams, circular layout, dominance drawing, and/or the like. As one concrete example, the graph arrangement algorithm may comprise the Cytoscape™ library. Cytoscape™ is an open-source software package for graph visualization. Although Cytoscape™ was originally designed for biological research, it is usage-agnostic and is currently used for complex graph analysis and visualization in a variety of other contexts.

In subprocess 240, the dimensions of the group, which was selected in subprocess 230 and arranged in subprocess 235, are calculated. It should be understood that each node in the graph will have a width and a height. The dimensions of the group may be calculated as the width and height of the smallest bounding box that contains all of the nodes in the arranged group. For instance, all of the nodes may be traversed to determine the rightmost, leftmost, topmost, and bottommost nodes. The horizontal distance between the rightmost point of the rightmost node and the leftmost point of the leftmost node may be calculated as the width, and the vertical distance between the topmost point of the topmost node and the bottommost point of the bottommost node may be calculated as the height.

In subprocess 245, the arranged group of nodes is replaced with a mock node having the dimensions calculated in subprocess 240. In other words, the arranged group is removed from the graph, and the mock node is added to the graph in the same position as the removed group. The mock node may have the same size and shape as the smallest bounding box that contains all of the nodes in the arranged graph. For instance, the mock node may have the width and height calculated in subprocess 240.

In addition, each edge, with a source end that is outside the arranged group and a destination end that is connected to the arranged group or any node within the arranged group, will instead have the destination end connected to the mock node. Similarly, each edge, with a destination end that is outside the arranged group and a source end that is connected to the arranged group or any node within the arranged group, will instead have the source end connected to the mock node. More generally, for each edge that has a first end connected outside the arranged group and a second end connected to the arranged group or a node within the arranged group, the second end of the edge will instead be connected to the mock node. To accomplish this task, server application 112 may traverse the entire graph to identify every edge that connects to the group or a node within the group, and, for each identified edge, switch the connection point from the arranged group or the node within the arranged group to the mock node.

The mock node acts as a temporary placeholder for the group within the graph, so that a standard graph arrangement algorithm, which does not account for groups of nodes, can be applied. It should be understood that, outside of the automated-arrangement process, a mock node has no existence. The mock node is not a component of the software application 170, and will never be seen by the user within graphical user interface 150. After the mock node has been inserted in place of the group within the graph, process 200 returns to subprocess 225.

After all of the groups have been replaced with mock nodes or if the graph contained no groups in the first place, the graph arrangement algorithm is applied to the entire graph in subprocess 260. The graph arrangement algorithm that is applied in subprocess 260 may be identical to the graph arrangement algorithm that is applied in subprocess 235. Alternatively, a different graph arrangement algorithm could be used in subprocess 260 than in subprocess 235. Regardless, at this point, the graph will not contain any groups. Thus, it is straightforward to apply the graph arrangement algorithm to the entire graph. The output of subprocess 260 will be an optimized arrangement of the nodes, which may include one or more actual nodes and/or one or more mock nodes in the graph, as well as edges in the graph that have not been subsumed by a mock node.

In subprocess 265, all of the mock nodes, if any, in the graph are replaced with their corresponding groups. Subprocess 265 represents a reversal of all iterations of subprocess 245, and may be performed in reverse order from iterations of subprocesses 245. In particular, the replacements may be performed from the first or highest level of depth to the last or lowest level of depth. More generally, any shallower mock nodes are replaced before any deeper mock nodes. In other words, each mock node in the graph will be replaced with the arranged group which it replaced (i.e., in a past iteration of subprocess 245), then any mock node in each of those group(s) may be replaced with the arranged group which it replaced, and so on and so forth, until no mock nodes remain in the graph. It should be understood that each of these replacements also comprises reconnecting the edges that were connected to the mock node, representing the group, to that group or appropriate node within that group. In other words, the group is fully restored to the arrangement that was previously output by subprocess 235 for that group. The output of subprocess 265 is the entire graph, comprising all of the nodes and no mock nodes, in a final arrangement. Generally, this output arrangement will differ and represent an improvement in the layout and organization over the input arrangement existing in graphical user interface 150 before execution of the automated-arrangement process. However, in circumstances in which the input arrangement is already optimized (e.g., a very simple software application 170), the output arrangement could be identical to the input arrangement.

In subprocess 270, graphical user interface 150 is updated to reflect the arrangement of the graph output by subprocess 265. In particular, the screen, generated in subprocess 205, may be updated to reflect the output arrangement. In other words, the visual representations of the components and connections of the software application 170 will be positioned within the virtual canvas according to the output arrangement. The output arrangement of these visual representations may be represented in a data structure, output by subprocess 265, that comprises coordinates, relative to the virtual canvas, which define the position of each of the visual representations of components (i.e., nodes) and/or connections (i.e., edges) on the virtual canvas. The data structure may also comprise or define other information, such as the dimensions of the visual representations of components, the positions of bends within the connections, and/or the like. After graphical user interface 150 has been updated in subprocess 270, process 200 may return to subprocess 210 to await the next user operation.

Advantageously, the disclosed automated-arrangement process, comprising subprocesses 225-270, enables a standard graph arrangement algorithm to be used in a recursive multi-depth arrangement of a graph comprising grouped nodes. In particular, the automated-arrangement process utilizes a graph arrangement algorithm, which generates new arrangements for nodes and/or edges, to arrange each group from deepest to shallowest. After each arrangement of a group, that group is temporarily replaced with a mock node, so that the graph arrangement algorithm can operate seamlessly at the next, shallower level. Once all groups have been replaced with mock nodes, the entire graph is arranged using the graph arrangement algorithm, and then the arranged groups are restored by replacing each mock node in the arranged graph with the corresponding arranged group that it replaced.

### 3. Example Graphical User Interface

FIGS. 3A and 3B illustrate the automated arrangement of nodes within a screen 300 of graphical user interface 150, according to an embodiment. In particular, FIG. 3A illustrates screen 300 before execution of the automated-arrangement process, and FIG. 3B illustrates screen 300 after the execution of the automated-arrangement process. It should be understood that screen 300 is only one example and is illustrated with a certain layout, inputs, functionality, and the like that are non-essential to the disclosed embodiments.

Screen 300 may comprise a navigation frame 310 and a virtual canvas 320. Navigation frame 310 may comprise one or more inputs for navigating to functionality available through graphical user interface 150. For example, navigation frame 310 may comprise one or more component-type inputs 312 that enable the user to select a specific type of component to edit (e.g., in another screen). As another example, navigation frame 310 may comprise one or more tool inputs 314 for selecting a tool that provides some function (e.g., design of an application programming interface 172, import and/or export of the software application 170, macros, etc.).

Screen 300 may also comprise a virtual pallet 330 with a visual representation 332 of each type of component that is available to be added to virtual canvas 320. A user may select a visual representation 332 from virtual pallet 330 to add to virtual canvas 320. For example, the user may select (e.g., click via a mouse, contact via a touch-panel display, etc.) a visual representation 332, drag the selected visual representation 332 to a position on virtual canvas 320, and drop (e.g., release the mouse click, end contact, etc.) visual representation 332 at the position on virtual canvas 320. After placing visual representation 332 on virtual canvas 320, visual representation 332 may change to a new visual representation 322 of the component. In addition, immediately after placement, a dialog box may appear (e.g., be overlaid on screen 300) with one or more inputs for configuring the component. The user may continue to move a visual representation 322 around virtual canvas 320 as desired.

The user may place a plurality of visual representations 322 of components in this manner. The user may also place (e.g., via a drawing operation) visual representations 324 of connections, between the placed visual representations 322 of components, to implement connections between the corresponding components. The user may also configure a component via the corresponding visual representation 322, delete visual representations 322 and/or 324, and/or the like. It should be understood that each visual representation 322 reflects a node and each visual representation 324 represents an edge in the logical graph representing the current software application 170 that is visually represented and being constructed on virtual canvas 320.

Screen 300 may also comprise one or more inputs 340 to manage virtual canvas 320. Of particular relevance, input(s) 340 may comprise an auto-arrangement input 345. Auto-arrangement input 345 initiates the automated-arrangement process of process 200. In particular, when the user selects auto-arrangement input 345, the automated-arrangement process is initiated (i.e., “Yes” in subprocess 220). Other inputs 340 may include, for example, a magnifying glass input for searching virtual canvas 320, a search input for searching virtual canvas 320, a zoom-in input for zooming into virtual canvas 320, a zoom-out input for zooming out from virtual canvas 320, a center input for centering the graph within virtual canvas 320, a shortcuts input for showing available shortcuts, a settings input for adjusting settings of virtual canvas 320, and/or the like.

In an embodiment, after the automated-arrangement process has been performed and screen 300 has been updated, as illustrated in FIG. 3B, the user may be provided with an input for undoing the arrangement. For example, after the automated arrangement is performed, a dialog box may appear with an input for reverting to the prior arrangement (i.e., the input arrangement to the automated-arrangement process), or saving and/or otherwise continuing with the current arrangement.

In the illustrated example, the user has constructed a graph of software application 170 that consists of a start node (Start) connected to a first node (1), which is connected to a second node (2), which is connected via branches to a third node (3) and a fourth node (4), with the third node (3) connected to the fourth node (4), and the fourth node (4) connected to a fifth node (5). In addition, the second, third, and fourth nodes are grouped into Group A, and the first node and Group A are grouped into Group B. Notably, Group A is nested within Group B. The start node, Group B, and the fifth node are each at a depth level of one, the first node and Group A are each at a depth level of two, and the second, third, and fourth nodes are each at a depth level of three.

As illustrated in FIG. 3A, prior to the automated-arrangement process, the graph is disorganized, with little-to-no linearity and numerous bends in the edges. In contrast, as illustrated in FIG. 3B, after the automated-arrangement process, the graph is organized with maximized linearity and minimal bends in the edges. It should be understood that, between these two examples, the user has selected auto-arrangement input 345 to initiate the automated-arrangement process (i.e., subprocesses 225-270) of process 200. The user will not see any visual artifacts from these subprocesses, except the new arrangement of the graph, output by subprocess 265 and represented in screen 300, as a result of subprocess 270, as illustrated in FIG. 3B.

An example execution of the automated-arrangement process will now be described in detail with respect to the graph illustrated in FIGS. 3A and 3B. In the first iteration of subprocess 225, Groups A and B remain, so a first iteration of subprocesses 230-245 is performed. In this first iteration, Group A is selected in subprocess 230 since Group A is the deepest group, the graph arrangement algorithm is applied to Group A in subprocess 235 (i.e., to produce the relative arrangement of the second, third, and fourth nodes in FIG. 3B), the dimensions of the arranged Group A are calculated in subprocess 240, and Group A is replaced with a mock node of the same dimensions and attached edges in subprocess 245. In the second iteration of subprocess 225, Group B remains, so a second iteration of subprocesses 230-245 is performed. In this second iteration, Group B is selected in subprocess 230 since Group B is the deepest (and only) remaining group, the graph arrangement algorithm is applied to Group B in subprocess 235 (i.e., to produce the relative arrangement of the first node and Group A in FIG. 3B), the dimensions of the arranged Group B are calculated in subprocess 240, and Group B is replaced with a mock node of the same dimensions and attached edges in subprocess 245. It should be understood, that the mock node for Group B logically encompasses the mock node for Group A plus an additional node, and therefore, will necessarily be larger than the mock node for Group A. In the third iteration of subprocess 225, no groups remain, so process 200 proceeds to subprocess 260. In subprocess 260, the graph arrangement algorithm is applied to the entire graph to produce the relative arrangement of the start node, the mock node for Group B, and the fifth node in FIG. 3B. Next, in subprocess 265, the mock node for Group B is replaced with the determined arrangement of the first node and the mock node for Group A, and then the mock node for Group A is replaced with the determined arrangement for the second, third, and fourth nodes, to produce the final output arrangement. Finally, in subprocess 270, screen 300 is updated to the version shown in FIG. 3B.

### 4. Example Processing System

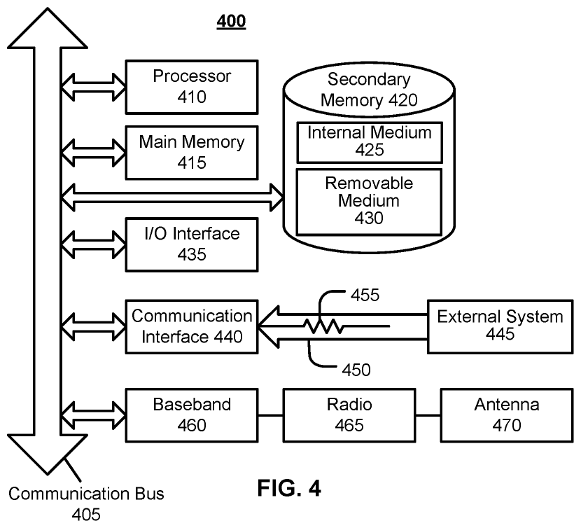

FIG. 4 illustrates an example processing system, by which one or more of the processes described herein may be executed, according to an embodiment. For example, system 400 may be used to store and/or execute software that implements process 200, and/or may represent components of platform 110, user system(s) 130, third-party system(s) 140, and/or other processing devices described herein. System 400 can be any processor-enabled device (e.g., server, personal computer, etc.) that is capable of wired or wireless data communication. Other processing systems and/or architectures may also be used, as will be clear to those skilled in the art.

System 400 may comprise one or more processors 410. Processor(s) 410 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 410. Examples of processors which may be used with system 400 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 410 may be connected to a communication bus 405. Communication bus 405 may include a data channel for facilitating information transfer between storage and other peripheral components of system 400. Furthermore, communication bus 405 may provide a set of signals used for communication with processor 410, including a data bus, address bus, and/or control bus (not shown). Communication bus 405 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 400 may comprise main memory 415. Main memory 415 provides storage of instructions and data for programs executing on processor 410, such as any of the software discussed herein. It should be understood that programs stored in the memory and executed by processor 410 may be written and/or compiled according to any suitable language, including without limitation C/C++, Java, JavaScript, Perl, Python, Visual Basic, .NET, and the like. Main memory 415 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 400 may comprise secondary memory 420. Secondary memory 420 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 400. The computer software stored on secondary memory 420 is read into main memory 415 for execution by processor 410. Secondary memory 420 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 420 may include an internal medium 425 and/or a removable medium 430. Internal medium 425 and removable medium 430 are read from and/or written to in any well-known manner. Internal medium 425 may comprise one or more hard disk drives, solid state drives, and/or the like. Removable storage medium 430 may be, for example, a magnetic tape drive, a compact disc (CD) drive, a digital versatile disc (DVD) drive, other optical drive, a flash memory drive, and/or the like.

System 400 may comprise an input/output (I/O) interface 435. I/O interface 435 provides an interface between one or more components of system 400 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 400 may comprise a communication interface 440. Communication interface 440 allows software to be transferred between system 400 and external devices, networks, or other information sources. For example, computer-executable code and/or data may be transferred to system 400 from a network server via communication interface 440. Examples of communication interface 440 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 400 with a network (e.g., network(s) 150) or another computing device. Communication interface 440 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 440 is generally in the form of electrical communication signals 455. These signals 455 may be provided to communication interface 440 via a communication channel 450 between communication interface 440 and an external system 445. In an embodiment, communication channel 450 may be a wired or wireless network (e.g., network(s) 120), or any variety of other communication links. Communication channel 450 carries signals 455 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 415 and/or secondary memory 420. Computer-executable code can also be received from an external system 445 via communication interface 440 and stored in main memory 415 and/or secondary memory 420. Such computer-executable code, when executed, enables system 400 to perform the various functions of the disclosed embodiments as described elsewhere herein.

In an embodiment that is implemented using software, the software may be stored on a computer-readable medium and initially loaded into system 400 by way of removable medium 430, I/O interface 435, or communication interface 440. In such an embodiment, the software is loaded into system 400 in the form of electrical communication signals 455. The software, when executed by processor 410, preferably causes processor 410 to perform one or more of the processes and functions described elsewhere herein.

System 400 may optionally comprise wireless communication components that facilitate wireless communication over a voice network and/or a data network (e.g., in the case of user system 130). The wireless communication components comprise an antenna system 470, a radio system 465, and a baseband system 460. In system 400, radio frequency (RF) signals are transmitted and received over the air by antenna system 470 under the management of radio system 465.

In an embodiment, antenna system 470 may comprise one or more antennae and one or more multiplexors (not shown) that perform a switching function to provide antenna system 470 with transmit and receive signal paths. In the receive path, received RF signals can be coupled from a multiplexor to a low noise amplifier (not shown) that amplifies the received RF signal and sends the amplified signal to radio system 465.

In an alternative embodiment, radio system 465 may comprise one or more radios that are configured to communicate over various frequencies. In an embodiment, radio system 465 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 465 to baseband system 460.

If the received signal contains audio information, then baseband system 460 decodes the signal and converts it to an analog signal. Then the signal is amplified and sent to a speaker. Baseband system 460 also receives analog audio signals from a microphone. These analog audio signals are converted to digital signals and encoded by baseband system 460. Baseband system 460 also encodes the digital signals for transmission and generates a baseband transmit audio signal that is routed to the modulator portion of radio system 465. The modulator mixes the baseband transmit audio signal with an RF carrier signal, generating an RF transmit signal that is routed to antenna system 470 and may pass through a power amplifier (not shown). The power amplifier amplifies the RF transmit signal and routes it to antenna system 470, where the signal is switched to the antenna port for transmission.

Baseband system 460 is communicatively coupled with processor(s) 410, which have access to memory 415 and 420. Thus, software can be received from baseband processor 460 and stored in main memory 410 or in secondary memory 420, or executed upon receipt. Such software, when executed, can enable system 400 to perform the various functions of the disclosed embodiments.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
generate a graphical user interface comprising a virtual canvas;
receive a placement on the virtual canvas of a plurality of nodes in a graph, wherein each node is a visual representation of a component of a software application;
receive a placement on the virtual canvas of one or more edges in the graph, wherein each edge is a visual representation of a connection between two components of the software application;
receive an automated-arrangement operation; and
in response to receiving the automated-arrangement operation,
determine whether or not the graph contains at least one group of two or more nodes,
when determining that the graph contains at least one group, until no groups remain,
select a deepest group in the graph,
apply a graph arrangement algorithm to the selected group to produce an arranged group,
calculate dimensions of the arranged group, and
replace the group in the graph with a mock node having the calculated dimensions,
apply the graph arrangement algorithm to an entirety of the graph,
after applying the graph arrangement algorithm to the entirety of the graph, replace each mock node in the graph with the group that was replaced by that mock node to produce a rearranged graph, and
update the placements on the virtual canvas of the plurality of nodes and the one or more edges, according to the rearranged graph.

2. The method of claim 1, wherein calculating the dimensions of the arranged group comprises calculating a width and height of a smallest bounding box that contains all nodes in the arranged group.

3. The method of claim 2, wherein the mock node has a shape and size of the smallest bounding box.

4. The method of claim 1, wherein replacing the group in the graph with the mock node comprises, for each edge that has a first end connected outside the arranged group and a second end connected to the arranged group or a node within the arranged group, connecting the second end of the edge to the mock node.

5. The method of claim 1, wherein replacing each mock node in the graph with the group that was replaced by that mock node comprises replacing any shallower mock nodes before replacing any deeper mock nodes.

6. The method of claim 1, wherein receiving the automated-arrangement operation comprises receiving a user selection of an auto-arrangement input in the graphical user interface.

7. The method of claim 1, wherein receiving the placement on the virtual canvas of the plurality of nodes in the graph comprises, for each of the plurality of nodes, receiving a drag-and-drop operation of the respective visual representation of the component from a virtual pallet onto the virtual canvas.

8. The method of claim 7, wherein receiving the placement on the virtual canvas of the one or more edges in the graph comprises, for each of the one or more edges, receiving a drawing operation of the respective visual representation of the connection between two visual representations of components.

9. The method of claim 1, wherein the graph arrangement algorithm optimizes an arrangement of nodes in the selected group according to one or more optimization criteria.

10. The method of claim 1, further comprising using the at least one hardware processor:
receive a deployment operation; and
in response to receiving the deployment operation, generate the software application according to the graph, and deploy the software application to a software environment.

11. A system comprising:
at least one hardware processor; and
software that is configured to, when executed by the at least one hardware processor,
generate a graphical user interface comprising a virtual canvas,
receive a placement on the virtual canvas of a plurality of nodes in a graph, wherein each node is a visual representation of a component of a software application,
receive a placement on the virtual canvas of one or more edges in the graph, wherein each edge is a visual representation of a connection between two components of the software application,
receive an automated-arrangement operation, and
in response to receiving the automated-arrangement operation,
determine whether or not the graph contains at least one group of two or more nodes,
when determining that the graph contains at least one group, until no groups remain,
select a deepest group in the graph,
apply a graph arrangement algorithm to the selected group to produce an arranged group,
calculate dimensions of the arranged group, and
replace the group in the graph with a mock node having the calculated dimensions,
apply the graph arrangement algorithm to an entirety of the graph,
after applying the graph arrangement algorithm to the entirety of the graph, replace each mock node in the graph with the group that was replaced by that mock node to produce a rearranged graph, and
update the placements on the virtual canvas of the plurality of nodes and the one or more edges, according to the rearranged graph.

12. A non-transitory computer-readable medium having instructions stored therein, wherein the instructions, when executed by a processor, cause the processor to:
generate a graphical user interface comprising a virtual canvas;
receive a placement on the virtual canvas of a plurality of nodes in a graph, wherein each node is a visual representation of a component of a software application;
receive a placement on the virtual canvas of one or more edges in the graph, wherein each edge is a visual representation of a connection between two components of the software application;
receive an automated-arrangement operation; and
in response to receiving the automated-arrangement operation,
determine whether or not the graph contains at least one group of two or more nodes,
when determining that the graph contains at least one group, until no groups remain,
select a deepest group in the graph,
apply a graph arrangement algorithm to the selected group to produce an arranged group,
calculate dimensions of the arranged group, and
replace the group in the graph with a mock node having the calculated dimensions,
apply the graph arrangement algorithm to an entirety of the graph,
after applying the graph arrangement algorithm to the entirety of the graph, replace each mock node in the graph with the group that was replaced by that mock node to produce a rearranged graph, and
update the placements on the virtual canvas of the plurality of nodes and the one or more edges, according to the rearranged graph.
